(19) United States
(12) Patent Application Publication
(10) Pub. No.: US 2022/0354720 A1
(43) Pub. Date: Nov. 10, 2022

(54) BED RAIL SAFETY GUARD

(71) Applicant: Stander Inc., Logan, UT (US)

(72) Inventors: F. Troy Miller, Logan, UT (US); Troy Holland, Providence, UT (US); Kip D. Alder, Nibley, UT (US); Adam Scott, Providence, UT (US); Benjamin Miller, Logan, UT (US); Brandon Birch, Nibley, UT (US)

(21) Appl. No.: 17/660,264

(22) Filed: Apr. 22, 2022

Related U.S. Application Data
(60) Provisional application No. 63/183,769, filed on May 4, 2021.

(51) Int. Cl. A61G 7/05

(52) U.S. Cl. CPC A61G 7/0508

(57) ABSTRACT

Safety guards for use with a bed rail are disclosed. A safety guard may be coupled to a mattress without being coupled to a bed rail, or a safety guard may be coupled to a mattress and to a bed rail. The safety guards may reduce a risk of entrapment between the mattress and the bed rail by distributing weight on the mattress across a wide surface area. A safety guard may be disposed underneath a sheet on the mattress. The safety guard may remain coupled to the mattress without inhibiting changing of sheets on the mattress.

### RELATED APPLICATION

This application claims priority to U.S. Provisional Application No. 63/183,769 filed on May 4, 2021 and titled BED RAIL SAFETY GUARD, which is incorporated by reference in its entirety.

### TECHNICAL FIELD

The present disclosure relates generally to the field of safety equipment for mobility assistance devices. More particularly, some embodiments relate to safety guards for bed rails.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of an embodiment of a bed rail safety guard.

FIG. 2 is a perspective view of an embodiment of a bed rail safety guard assembly.

FIG. 3 is a perspective view of the bed rail safety guard assembly of FIG. 2 in a folded configuration, as it may be configured when wrapped around a mattress.

FIG. 4 is a perspective view of an embodiment of a bed rail safety guard assembly in a folded configuration, as it may be configured when wrapped around a mattress.

FIG. 5 is a perspective view of the bed rail safety guard assembly of FIG. 2 wrapped around a mattress on a bed.

FIG. 6 is a perspective view of the bed rail safety guard assembly of FIG. 2 wrapped around a mattress on a bed, with a bed rail installed adjacent to the safety guard assembly.

FIG. 7 is a side view of the bed rail safety guard assembly of FIG. 2 coupled to a mattress, with a bed rail installed adjacent to the safety guard assembly.

FIG. 8 is a perspective view of the bed rail safety guard assembly of FIG. 2 wrapped around a mattress and underneath a fitted sheet, with a bed rail installed adjacent to the safety guard assembly.

FIG. 9 is a perspective view of an embodiment of a bed rail safety guard assembly in a folded configuration, as it may be configured when wrapped around a mattress, with the safety guard assembly coupled to a bed rail.

FIG. 10 is an elevation view of an embodiment of a bed rail safety guard assembly wrapped around a mattress, with the safety guard assembly coupled to a bed rail.

### DETAILED DESCRIPTION

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is broad enough to refer to any suitable coupling or other form of interaction between two or more entities, including mechanical interaction. Thus, two components may be coupled to each other even though they are not in direct contact with each other. The phrases “attached to” or “attached directly to” refer to interaction between two or more entities which are in direct contact with each other and/or are separated from each other only by a fastener of any suitable variety (e.g., mounting hardware or an adhesive).

References to approximations are made throughout this specification, such as by use of the term “substantially.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers. For example, where the term “substantially perpendicular” is recited with respect to a feature, it is understood that in some embodiments the feature may have a precisely perpendicular configuration.

The term “lateral” refers to a direction spanning across the width of a bed, from side to side. The term “longitudinal” refers to a direction spanning across the length of a bed, from head to foot. A longitudinal direction and a lateral direction are substantially perpendicular to each other, and each is substantially perpendicular to a vertical direction.

The embodiments disclosed herein may be used as safety guards to reduce a risk of entrapment between a mattress and a bed rail by distributing weight on the mattress across a wide surface area. Entrapment includes a condition in which a part of a person's body—such as a person's head, neck, or limb—gets stuck between a bed rail and a part of a bed, such as the mattress. Entrapment presents a serious problem to care givers and their patients because it can lead to serious injury or death.

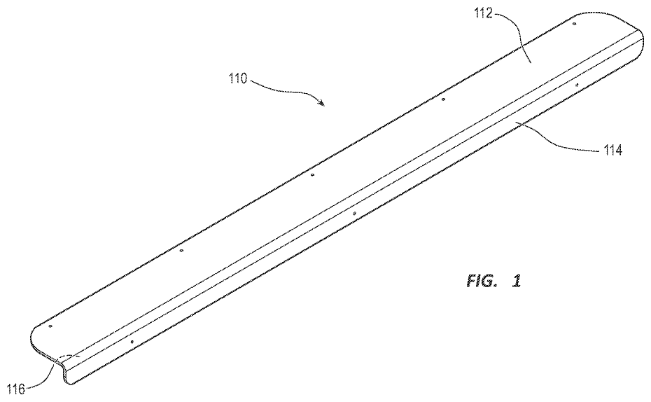

FIG. 1 depicts an embodiment of a bed rail safety guard (or simply “safety guard”) 110. The safety guard 110 may include an upper portion 112 and a side portion 114. The safety guard 110 may have a long dimension that is configured to be oriented in a bed's longitudinal direction when installed on the bed. The safety guard 110 may have a substantially L-shaped cross section, with one arm of the “L” comprising the upper portion 112, and the other arm of the “L” comprising the side portion 114. The safety guard 110 may also include an inner surface 116, wherein the inner surface 116 comprises the inside bend of the “L” shape. The inner surface 116 may comprise a substantially sharp corner, or may comprise a concave curve. The inner surface 116 may be configured to conform to an edge of a mattress, lending the safety guard 110 the ability to be snugly coupleable to the mattress. For example, a concave curve of the inner surface 116 may conform to an upper edge of the mattress.

The upper portion 112 and the side portion 114 may be thin members configured to have low profiles when installed on a mattress. For example, the thickness of the upper portion 112 and of the side portion 114 may be less than one centimeter, including approximately four millimeters. Such a small thickness relative to a mattress allows the safety guard 110 to conform closely to the mattress's profile, thus not extending substantially above an upper surface of the mattress, or substantially beyond a side surface of the mattress. In this way, the safety guard 110 permits placement of sheets on the mattress and over the safety guard.

The safety guard 110 may be configured to extend along an edge of the mattress. Safety guards of various lengths are contemplated by this disclosure. A safety guard may be configured for small bed rails, bed handles, or bed canes, and may have a length between eighteen and thirty-six inches, including approximately twenty-four inches or approximately thirty inches. Or, the safety guard may be configured for large bed rails, and may have a length between thirty inches and sixty inches, including approximately thirty-eight inches or approximately forty-six inches. The safety guard 110 may be elongate in shape, with a width or widths significantly less than its length. For example, the upper portion 112 may have a width between two and six inches, including approximately four inches. The side portion 114 may have a width (or height, as viewed when the safety guard 110 is installed on a mattress) between one and six inches, including approximately one and a half inches or approximately two inches. The safety guard 110 may have rounded corners.

The safety guard 110 may be substantially rigid or stiff, so as to withstand a vertical force from a weight placed above the safety guard 110 on the mattress. The safety guard 110 may thereby distribute the force of the weight across part or all of the length and width of the safety guard 110. This consequently increases the mattress surface area that supports the weight, thus reducing stresses in the mattress and reducing the extent of deformation or depression of an upper surface of the mattress under the weight. By reducing the extent of upper surface depression of the mattress, a risk of potential entrapment between the mattress and a bed rail may be reduced. For example, in situations without the safety guard 110, weight on an upper edge of the mattress may deform the mattress enough to form a significant vertical gap between the mattress and a bed rail that is adjacent to the edge of the mattress. The vertical gap formed when the mattress is compressed may be large enough to entrap a part of a person's body—such as the person's head, neck, or limb—between the bed rail and the mattress.

The safety guard 110 may be constructed of any suitable material that can distribute weight over a larger area than the contact area of the source of the weight on the mattress. For example, the safety guard 110 may be made of a polymer, including polypropylene, polyvinyl chloride, polyethylene, or any other suitable polymer. Alternatively, the safety guard 110 may be made of a metal such as aluminum sheet or some other suitable metal.

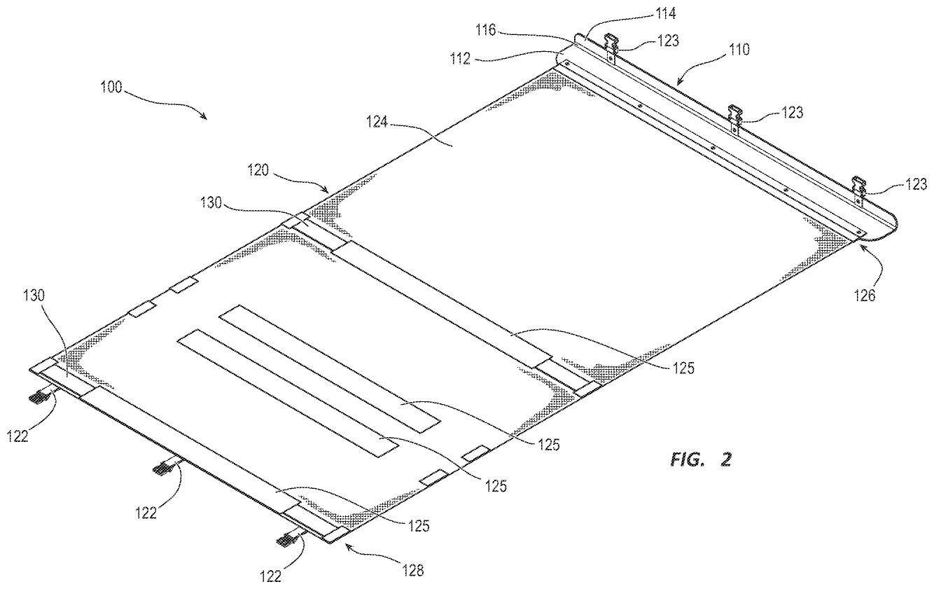

FIG. 2 depicts an embodiment of a bed rail safety guard assembly (or simply “safety guard assembly”) 100. The safety guard assembly 100 may include the safety guard 110 (such as that described in connection with FIG. 1) and a flexible securing member 120. The flexible securing member 120 may include one or more straps 122. The flexible securing member 120 may also include a fabric 124. In the depicted embodiment, the flexible securing member 120 contains a fabric 124 and three straps 122. However, embodiments with fewer than three straps 122 or more than three straps 122 are also contemplated within this disclosure. The fabric 124 may have a width (the dimension in a bed's longitudinal direction when installed on the bed) sufficiently large to provide the safety guard 110 with a stable, secure position on an edge of a mattress. In some embodiments, the width of the fabric 124 may be at least half of the length of the safety guard 110. In some embodiments, the width of the fabric 124 may amount to a large majority of the length of the safety guard 110, such as that shown in FIG. 2. In some embodiments, the width of the fabric 124 may be the full length of the safety guard 110.

The safety guard assembly 100 may additionally include one or more stiffening members 130. The stiffening members 130 may provide rigidity to the flexible securing member 120, and particularly the fabric 124, so as to prevent bunching of the fabric 124 when installed around a mattress. The stiffening members 130 may be attached to or fully contained within the flexible securing member 120. Or, the stiffening members 130 may be removably insertable into the flexible securing member 120, such as into folds or pockets 125 of the fabric 124. The flexible securing member 120 may be configured such that the stiffening members 130, when inserted into the flexible securing member 120, are aligned in the longitudinal direction (that is, the long dimension of each stiffening member 130 is substantially parallel to the long dimension of the safety guard 110). The stiffening members 130 may be located on the flexible securing member 120 such that, when the safety guard assembly 100 is installed around a mattress, at least one stiffening member 130 is on a lateral side of the mattress opposite from the location of the safety guard 110. Additionally, the stiffening members 130 may be located such that none of the stiffening members 130 rest above an upper surface of the mattress. In this way, the stiffening members 130 may remain apart from the top of the bed so that a user does not encounter them, and so that they do not bother the user.

As seen in FIG. 2, the fabric 124 may have more folds or pockets 125 than there are stiffening members 130. These additional folds or pockets 125 allow for selective insertion of the stiffening members 130 into the fabric 124, which may be useful for installation of the safety guard assembly 100 around differently sized mattresses. For example, a full size mattress may call for different placement of the stiffening members 130 in the fabric 124 than what a queen size mattress requires. The stiffening members 130 may be made of a polymer, including polypropylene, polyvinyl chloride, polyethylene, or any other suitable polymer. Alternatively, the stiffening members 130 may be made of a metal such as aluminum or some other suitable metal. In some embodiments, the stiffening members 130 may be additional stitching on the fabric 124 to reinforce a longitudinal section of the fabric 124.

The flexible securing member 120 may be coupled to the safety guard 110. The flexible securing member 120 may have a first end 126 that can be connected to the upper portion 112 of the safety guard 110. In the illustrated embodiment, the first end 126 is attached to the upper portion 112 with rivets. The first end 126 may be coupled to the upper portion 112 in a variety of different ways, such as with mechanical fasteners such as nuts and bolts, screws, and the like or by adhesives. Alternatively, the first end 126 may be looped through a slot in the upper portion 112 and secured to itself, for example with stitching. The first end 126 may include an additional member, such as a stiffening member (similar to the stiffening members 130), to provide additional strength to the fabric 124 at the first end 126. For example, the fabric 124 at the first end 126 may wrap around a stiffening member, and the rivets may pass through the upper portion 112, a first segment of the fabric 124, the stiffening member, and a second segment of the fabric 124. This may help to prevent tearing or ripping of the fabric 124 at the first end 126.

The flexible securing member 120 may have a second end 128 that is coupleable to the side portion 114 of the safety guard 110. The second end 128 may include the one or more straps 122. The straps 122 may be attached to the fabric 124 with stitching or another suitable attachment means. The fabric 124 may be configured to accommodate a stiffening member 130 at the second end 128, at or near the location where the straps 122 are attached to the fabric 124.

The straps 122 may be coupled to buckles or clasps for securing the second end 128 to the safety guard 110. In the depicted embodiment, the three straps 122 are each looped through a first member of a side release buckle, while corresponding straps 123 coupled to the side portion 114 of the safety guard 110 are each looped through a second, mating member of the side release buckle. These buckles enable the safety guard assembly 100 to be installed around a mattress efficiently. In some other embodiments, the mechanism for coupling the second end 128 to the safety guard 110 may be a frame-and-prong buckle, a magnetic buckle, a hook-and-loop strap fed through a ring, a strap with snap fasteners, or any other suitable coupling mechanism.

The buckles or fasteners on the straps 122 may be slidably adjustable to configure the flexible securing member 120 with varying lengths suitable for differently sized mattresses. For example, the straps 122 may have a large length, such as approximately two and a half meters, to accommodate a variety of mattress sizes. Thus, the second end 128 may be increased or decreased in length as needed in a particular circumstance. When additional length is needed, the first buckle members may be slid along the straps 122 to an appropriate location. Any excess strap length may be stowed underneath the mattress.

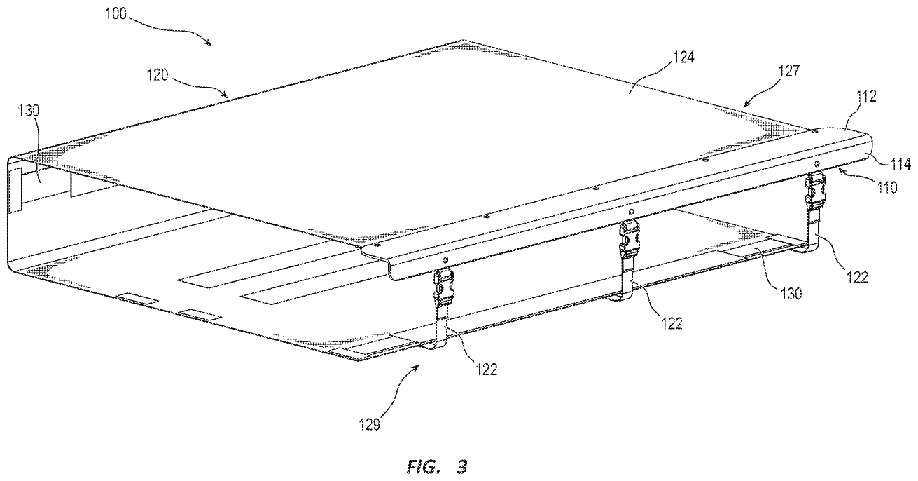

FIG. 3 depicts the safety guard assembly 100 in a folded configuration. For simplicity, FIG. 3 does not depict a mattress. However, the configuration of the safety guard assembly 100 shown in FIG. 3 is the shape that the safety guard assembly 100 may take when installed around a mattress. The exact configuration of the safety guard assembly 100 may vary due to the size of the mattress that the safety guard assembly 100 is coupled to. The flexible securing member 120 may be configured to wrap substantially around the mattress and secure the safety guard 110 to an upper edge of the mattress. A first portion 127 of the flexible securing member 120 comprises the fabric 124, and a second portion 129 of the flexible securing member 120 comprises the one or more straps 122. The first portion 127 is coupled to the upper portion 112 of the safety guard 110, and the second portion 129 is coupleable to the side portion 114 of the safety guard 110. In the illustrated embodiment, the second portion 129 is coupled to the side portion 114 by the straps 122. When fully installed, the first portion 127 may extend across an upper surface of the mattress, the second portion 129 may extend across at least a portion of a lower surface of the mattress, and the safety guard assembly 100 may completely wrap around a longitudinal axis of the mattress, thus encompassing the mattress. In some embodiments, the first portion 127 may extend across at least a portion of the lower surface of the mattress. In some embodiments, the first portion 127 might not extend across the lower surface of the mattress. In some embodiments, the second portion 129 may extend across at least a portion of the side of the mattress on the same side as the safety guard 110, across the lower surface of the mattress, and across a portion of the opposing side of the mattress opposite the safety guard 110.

FIG. 3 further illustrates the stiffening members 130. In the illustrated embodiment, a stiffening member 130 is located on the fabric 124, on a side of the safety guard assembly 100 opposite the safety guard 110. Another stiffening member 130 is located on the fabric 124, on the bottom of the safety guard assembly 100 at a location near where the straps 122 are attached to the fabric 124. The top of the safety guard assembly 100 may omit stiffening members 130 so that they are not felt by a user of the bed when the safety guard assembly 100 is installed.

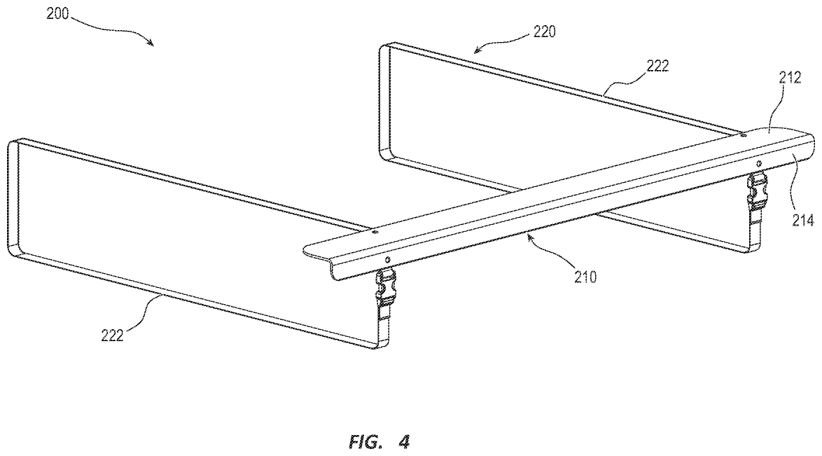

Various embodiments of a bed rail safety guard assembly are disclosed herein. In certain respects, the various embodiments may resemble each other. Accordingly, like features are designated with like reference numerals, with the hundreds place digits incremented. FIG. 4 depicts an embodiment of a safety guard assembly 200 in a folded configuration that resembles the safety guard assembly 100 described above in certain respects. For example, the embodiment depicted in FIG. 4 includes a safety guard 210 that may, in some respects, resemble the safety guard 110 of FIG. 3. Relevant disclosure set forth herein regarding similarly identified features thus might not be repeated. Moreover, specific features of a bed rail safety guard assembly and related components might not be shown or identified by a reference numeral in all drawings, or specifically discussed in the corresponding written description. However, such features may clearly be the same, or substantially the same, as features depicted in other embodiments and/or described with respect to such embodiments. Accordingly, the relevant descriptions of such features apply to the like features and related components depicted as different embodiments. Thus, for example, any suitable combination of the features, and variations of the same, described with respect to the safety guard assembly 100 and related components illustrated in FIG. 3 can be employed with the safety guard assembly 200 and related components of FIG. 4, and vice versa. This pattern of disclosure applies equally to further embodiments depicted in subsequent figures and described in their corresponding written descriptions, wherein the hundreds place digits may be further incremented.

As with FIG. 3, FIG. 4 does not depict a mattress, but the configuration of the safety guard assembly 200 shown in FIG. 4 is the shape that the safety guard assembly 200 may take when installed around a mattress. The exact configuration of the safety guard assembly 200 may vary due to the size of the mattress that the safety guard assembly 200 is coupled to. The safety guard assembly 200 may include the safety guard 210 and a flexible securing member 220. The flexible securing member 220 may include one or more straps 222 without a fabric. In the illustrated embodiment, the flexible securing member 220 includes two straps 222. The straps 222 may be coupled to the safety guard 210. For example, one end of a strap 222 may be riveted to an upper portion 212 of the safety guard 210, and the other end of the strap 222 may be coupleable to a side portion 214 of the safety guard 210 with a buckle mechanism in a similar fashion to the embodiment shown in FIG. 3. The straps 222 may be coupled to the upper portion 212 by any other mechanical fastener or adhesive. Alternatively, the straps 222 may loop through slots in the safety guard 210, with one end of each strap 222 coupling to the other end with a buckle, hook-and-loop portion, snap fastener, or some other coupling mechanism.

The flexible securing member 220 may be adjustable to accommodate a variety of mattress sizes, similar to the flexible securing member 120. The flexible securing member 220 may be configured to wrap substantially around a mattress and secure the safety guard 210 to an upper edge of the mattress. When fully installed, the safety guard assembly 200 may completely wrap around a longitudinal axis of a mattress, thus encompassing the mattress.

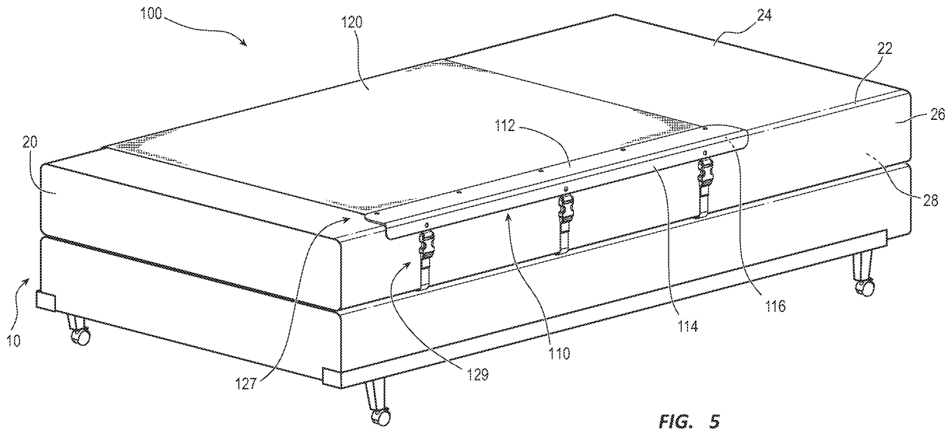

FIG. 5 depicts the safety guard assembly 100 installed around a mattress 20 of a bed 10. When the safety guard assembly 100 is installed, the safety guard 110 is secured to the mattress 20. The upper portion 112 of the safety guard 110 may rest on or be disposed on an upper surface 24 of the mattress 20. Similarly, the side portion 114 of the safety guard 110 may be disposed on a side surface 26 of the mattress 20. The inner surface 116 may be disposed on an upper edge 22 of the mattress 20. The inner surface 116 may include a concave curve that conforms to the upper edge 22.

As can be seen in FIG. 5, the safety guard 110 may have a thin profile, such that the upper portion 112 does not extend substantially above the upper surface 24 of the mattress 20, and such that the side portion 114 does not extend substantially beyond the side surface 26 of the mattress 20.

As described above in connection with FIG. 3, the first portion 127 of the flexible securing member 120 may extend across the upper surface 24 of the mattress 20, and the second portion 129 of the flexible securing member 120 may extend across at least a portion of a lower surface 28 of the mattress 20.

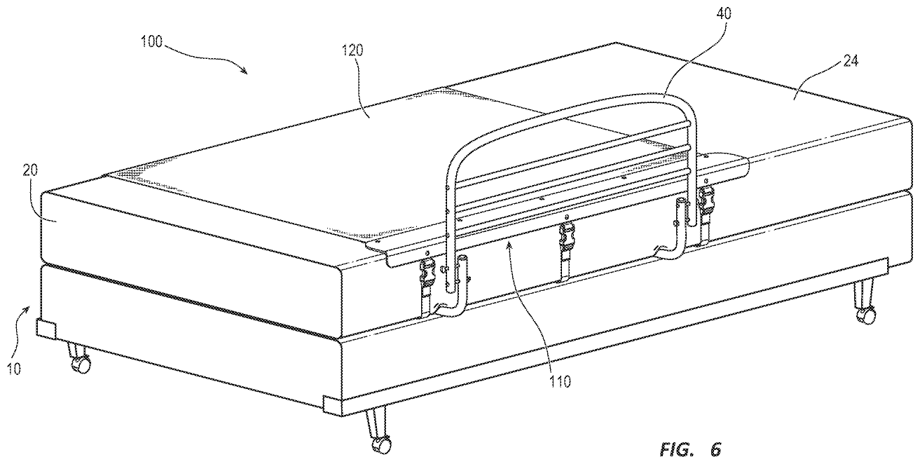

FIG. 6 depicts the safety guard assembly 100 installed around a mattress 20 of a bed 10, and a bed rail 40 installed adjacent the safety guard 110. In this embodiment, the safety guard assembly 100 is not coupled to the bed rail 40. The safety guard assembly 100 may be used with a variety of bed rails.

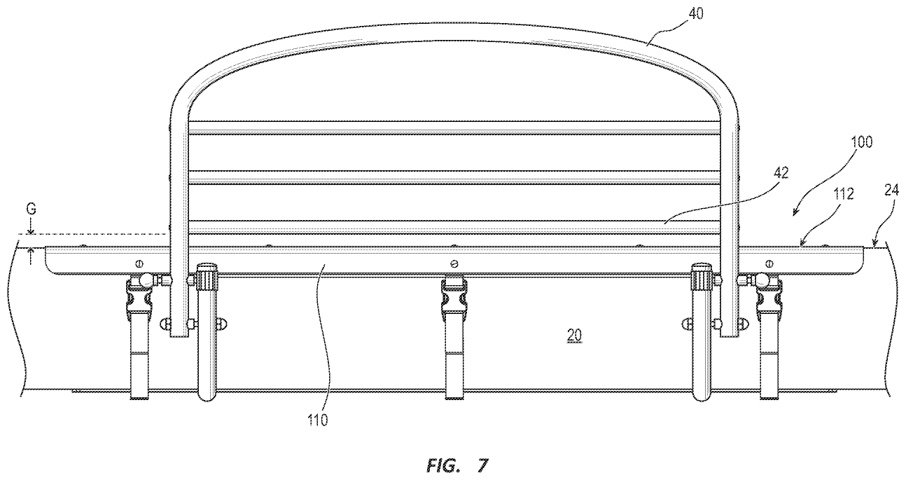

FIG. 7 depicts a side view of the safety guard assembly 100 installed around the mattress 20, along with the bed rail 40 installed adjacent the safety guard 110.

Typically, bed rails are constructed so as to prevent entrapment in their internal spaces (such as between rungs or other members of the bed rail). Yet, without a safety guard, a potential entrapment risk may persist between the bed rail 40 and the mattress 20 of the bed 10. For example, a significant vertical gap G between an upper surface 24 of the mattress 20 and the bottom rung 42 of the bed rail 40 may develop. With some mattresses, the entrapment risk may be low because the upper surface 24 may be relatively high, and the mattress 20 may be relatively firm. In this way, there may be only a small vertical gap G, or no vertical gap, and weight on the mattress 20 may only minimally compress the upper surface 24. With some other mattresses, however, the entrapment risk may be more pronounced because the upper surface 24 may be relatively low (in relation to the bottom rung 42 of the bed rail 40, resulting in a large vertical gap G), and/or the mattress 20 may be relatively soft (e.g., pillow top mattresses) and thus susceptible to large depressions or deformations when weight is placed on the upper surface 24. For example, on a soft mattress, a user's body or limb may compress the upper surface 24 a great degree, thus forming a larger vertical gap G than initially present. In this way, the user's limb, head, or neck may be vulnerable to getting stuck between the mattress 20 and the bottom rung 42 of the bed rail 40.

The safety guard 110 may help to reduce this risk of entrapment. When coupled to the mattress 20, the safety guard 110 may be able to spread the force of a weight on the safety guard 110 across a wider area of the upper surface 24 of the mattress 20 than the surface area that would otherwise absorb the force of the weight without the safety guard 110. By distributing the force of the weight across a wider area, the safety guard 110 may reduce the pressure on the upper surface 24 of the mattress 20 resulting from the weight, and may effectively decrease the extent to which the upper surface 24 deforms and depresses. Consequently, the likelihood of a large vertical gap G forming between the mattress 20 and the bed rail 40 will be reduced, and the risk of entrapment will be lowered.

In the view of FIG. 7, it can be seen that the vertical gap G between the upper surface 24 and the bottom rung 42 of the bed rail 40 is small (e.g., smaller than the vertical gaps between rungs of the bed rail 40). Without the safety guard 110, the vertical gap G between the upper surface 24 and the bottom rung 42 could increase and pose an entrapment risk if the upper surface 24 of the mattress 20 were significantly compressed at a location near the bed rail 40. The safety guard 110 mitigates that entrapment risk by distributing the force of a weight—that would otherwise significantly compress the upper surface 24 of the mattress 20—across a wide area. In this way, the safety guard 110 may help keep the vertical gap G small (or nonexistent), thus reducing the likelihood of entrapment. The area of distribution of the compressive force from the weight may span approximately the length and width of the upper portion 112 of the safety guard 110.

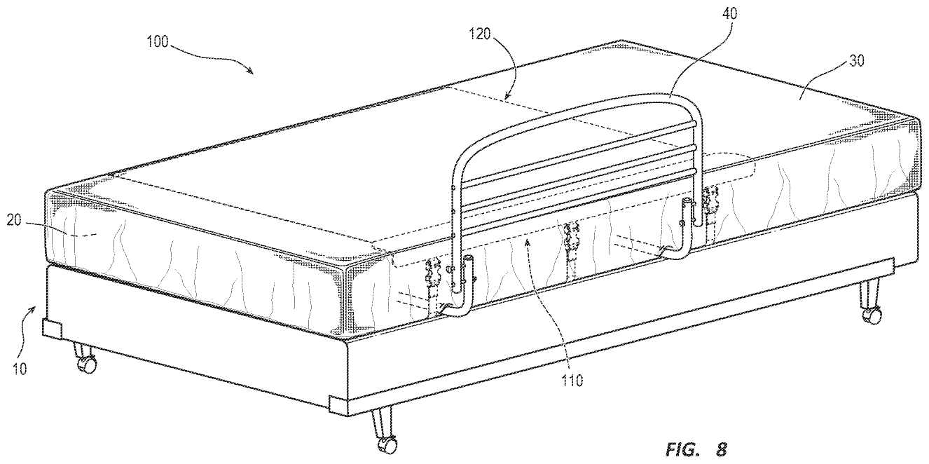

FIG. 8 depicts the safety guard assembly 100 installed around a mattress 20 of the bed 10, the bed rail 40 installed adjacent the safety guard 110, and a sheet 30 placed on the mattress 20. The sheet 30 may cover and encompass the mattress 20. The sheet 30 may be a fitted sheet, a flat sheet, or some other kind of sheet. In the illustrated scene, the sheet 30 is a fitted sheet.

The safety guard assembly 100 is illustrated in FIG. 8 with hidden lines to indicate that it is disposed underneath the sheet 30. The installation of the safety guard assembly 100 around the mattress does not interfere with placement of the sheet 30 around the mattress 20. This is possible in part because the safety guard 110 is shaped to conform to the edge of the mattress 20, and further shaped with a low profile, and because the flexible securing member 120 wraps snugly around the mattress 20. Additionally, in some embodiments, including the embodiment of the safety guard assembly 100, the safety guard 110 and the flexible securing member 120 are not coupleable to the bed rail 40, thus allowing the sheet 30 to fit through a lateral gap between the safety guard assembly 100 and the bed rail 40.

The safety guard assembly 100 does not impede changing of the sheet 30. The sheet 30 may be removed and replaced without the need to remove, move, or adjust the safety guard assembly 100.

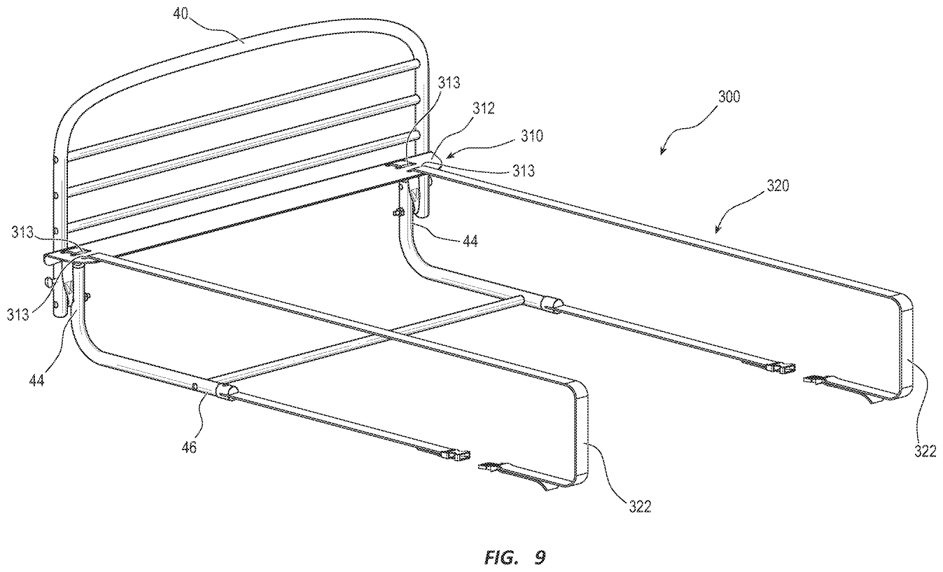

FIG. 9 depicts an embodiment of a safety guard assembly 300 in a folded configuration. As with FIGS. 3 and 4, FIG. 9 does not depict a mattress, but the configuration of the safety guard assembly 300 shown in FIG. 9 is the shape that the safety guard assembly 300 may take when installed around a mattress. The exact configuration of the safety guard assembly 300 may vary due to the size of the mattress that the safety guard assembly 300 is coupled to. The safety guard assembly 300 may include a safety guard 310 and a flexible securing member 320. The flexible securing member 320 may include one or more straps 322 without a fabric. In the illustrated embodiment, the flexible securing member 320 includes two straps 322. The straps 322 may be coupled to the safety guard 310, but may additionally be coupled to a bed rail 40. For example, on one end, the straps 322 may be riveted to an upper portion 312 of the safety guard 310 (not shown in FIG. 9, but similar to the embodiment shown in FIG. 4), and on the other end, the straps 322 may be coupled to a base 46 of the bed rail 40. Alternatively, the straps 322 may loop through slots 313 in the safety guard 310 with both ends of each strap 322 coupling to the bed rail 40. As shown in FIG. 9, a first end of each strap 322 may couple to a post 44 of the bed rail 40, and a second end of each strap 322 may couple to the base 46 of the bed rail 40.

The flexible securing member 320 may be adjustable to accommodate a variety of mattress sizes, similar to the flexible securing member 120. For example, the length of the straps 322 may be adjusted by lengthening or shortening the straps 322 to accommodate differently sized mattresses. The flexible securing member 320 may be configured to wrap substantially around a mattress and secure the safety guard 310 to an upper edge of the mattress. When fully installed, the safety guard assembly 300 may completely wrap around a longitudinal axis of a mattress, thus encompassing the mattress.

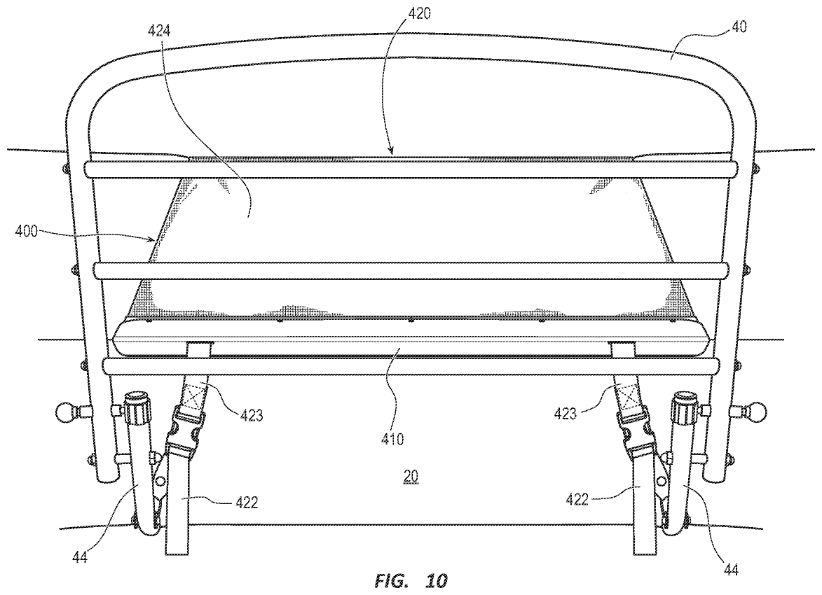

FIG. 10 depicts an embodiment of a safety guard assembly 400 installed around a mattress 20, and a bed rail 40 installed adjacent a safety guard 410. The safety guard assembly 400 may include the safety guard 410 and a flexible securing member 420. The flexible securing member 420 may include one or more straps 422, one or more corresponding straps 423, and a fabric 424. The fabric 424 may couple to the base of the bed rail 40, for example with the aid of straps in a similar fashion to the straps 322 shown in FIG. 9. The corresponding straps 423 may be coupled to the safety guard 410, and may include releasable buckles or other coupling mechanisms for coupling with the straps 422. The straps 422 may include releasable buckles or other coupling mechanisms for coupling with the corresponding straps 423, and may be coupled to the bed rail 40. For example, the straps 422 may each be coupled to a post 44 of the bed rail 40. Alternatively, the straps 422 may couple to both the safety guard 410 and to the bed rail 40, without the aid of the corresponding straps 423.

The flexible securing member 420 may be adjustable to accommodate a variety of mattress sizes, similar to the flexible securing member 120. The flexible securing member 420 may be configured to wrap substantially around the mattress 20 and secure the safety guard 410 to an upper edge of the mattress 20. When fully installed, the safety guard assembly 400 may completely wrap around a longitudinal axis of the mattress 20, thus encompassing the mattress 20.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

We claim:

1. A bed rail safety guard assembly, comprising:
a safety guard shaped to conform to and extend along an edge of a mattress; and
a flexible securing member coupled to the safety guard, wherein the flexible securing member couples the safety guard to the mattress.

2. The bed rail safety guard assembly of claim 1, wherein the safety guard is further shaped to not extend substantially above an upper surface of the mattress.

3. The bed rail safety guard assembly of claim 1, wherein the safety guard comprises a substantially rigid material configured to distribute weight disposed on the safety guard along a length of the safety guard.

4. The bed rail safety guard assembly of claim 1, wherein the safety guard comprises a substantially L-shaped cross section with an upper portion of the safety guard configured to be disposed on an upper surface of the mattress and a side portion of the safety guard configured to be disposed on a side surface of the mattress.

5. The bed rail safety guard assembly of claim 1, wherein an inner surface of the safety guard comprises a concave curve to conform to an upper edge of the mattress.

6. The bed rail safety guard assembly of claim 1, wherein the flexible securing member is configured to wrap substantially around the mattress.

7. The bed rail safety guard assembly of claim 1, wherein the flexible securing member comprises a strap.

8. The bed rail safety guard assembly of claim 1, wherein the flexible securing member comprises a fabric that extends along a majority of a length of the safety guard.

9. The bed rail safety guard assembly of claim 1, wherein the safety guard is not coupleable to a bed rail.

10. The bed rail safety guard assembly of claim 1, wherein the safety guard is coupleable to a bed rail.

11. A bed rail safety guard assembly, comprising:
a safety guard; and
a flexible securing member configured to couple the safety guard to an upper edge of a mattress,
wherein the bed rail safety guard assembly is configured to be disposed underneath a sheet covering the mattress.

12. The bed rail safety guard assembly of claim 11, wherein the sheet is a fitted sheet.

13. The bed rail safety guard assembly of claim 12, wherein the fitted sheet is changeable without adjustment of the bed rail safety guard assembly.

14. The bed rail safety guard assembly of claim 12, wherein the fitted sheet is changeable without removal of the bed rail safety guard assembly.

15. A bed rail safety guard assembly, comprising:
a safety guard; and
a flexible securing member configured to wrap substantially around a mattress and couple to the safety guard and secure the safety guard to an upper edge of the mattress.

16. The bed rail safety guard assembly of claim 15, wherein a first end of the flexible securing member couples to an upper portion of the safety guard and a second end of the flexible securing member couples to a side portion of the safety guard, and wherein the bed rail safety guard assembly is configured to completely wrap around and encompass the mattress.

17. The bed rail safety guard assembly of claim 15, wherein the flexible securing member is adjustable, thereby enabling the bed rail safety guard assembly to be coupleable to a variety of differently sized mattresses.

18. The bed rail safety guard assembly of claim 15, wherein the flexible securing member comprises a strap.

19. The bed rail safety guard assembly of claim 15, wherein the flexible securing member comprises a fabric that extends along a majority of a length of the safety guard.

20. The bed rail safety guard assembly of claim 19, wherein a first portion of the flexible securing member comprises the fabric and a second portion of the flexible securing member comprises at least one strap coupled to the fabric, wherein the first portion is configured to extend across an upper surface of the mattress and the second portion is configured to extend across at least a portion of a lower surface of the mattress.

21. The bed rail safety guard assembly of claim 19, further comprising a stiffening member, wherein the stiffening member is coupleable to the flexible securing member to prevent bunching of the fabric.

22. The bed rail safety guard assembly of claim 21, wherein the stiffening member is disposed within the flexible securing member.

23. The bed rail safety guard assembly of claim 21, wherein the stiffening member is configured to be disposed in a longitudinal direction of the mattress on a lateral side of the mattress that is opposite a location of the safety guard.
